(19) United States
(12) Patent Application Publication
(10) Pub. No.: US 2007/0031724 A1
(43) Pub. Date: Feb. 8, 2007

(54) Fuel cell, fuel cell assembly, and method for manufacturing the fuel cell

(75) Inventor: Chuan-De Huang, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/400,883

(22) Filed: Apr. 10, 2006

(30) Foreign Application Priority Data
Aug. 3, 2005 (CN) 200510036389.6

(51) Int. Cl. H01M 4/96; H01M 8/02; H01M 4/92; B05D 5/12; H01M 4/88

(52) U.S. Cl. 429/44; 429/38; 427/115; 502/101

(57) ABSTRACT

A fuel cell includes two flow field plates and a membrane electrode assembly sandwiched therebetween. A plurality of flow channels is formed on surface facing the membrane electrode assembly of the flow field plate. A carbon material layer is formed on the flow field plate and a catalyst layer is formed on the carbon material layer. The invention also provides a method for manufacturing the fuel cell. The method includes the steps of: providing two flow field plates respectively having flow channels formed on a surface thereof; forming a carbon material layer on the surface having the flow channels of the flow field plates; depositing a catalyst layer on the carbon material layer; assembling the flow field plates and a membrane electrode assembly to form the fuel cell.

### BACKGROUND

1. Technical Field

The present invention relates to a fuel cell, a fuel cell assembly, and a method for manufacturing the fuel cell.

2. Description of Related Art

A fuel cell is an electrochemical device for continuously converting chemical energy into electrical energy at a suitable reaction temperature. Compared to other power sources fuel cells have the advantages of high efficiency, low-pollution, noiselessness, and continuously working, etc. The fuel cell is widely used in a variety of diverse fields such as military affairs, civil electric powers, traffics, communications, and so on.

Currently, fuel cells can be classified into alkaline fuel cells (AFCs), solid oxide fuel cells, proton exchange membrane fuel cells (PEMFCs), direct methanol fuel cells (DMFCs) etc. In recent years, PEMFCs have developed quickly. Generally, a PEMFC includes a membrane electrode assembly, two flow field plates, and two current collector plates.

The membrane electrode assembly is also referred to as a membrane electrode assembly cluster and is a core element of the PEMFC. On the membrane electrode assembly, an electrochemical reaction occurs between oxidizer and fuel gas. Thereby, water and electrons are produced. The membrane electrode assembly generally includes an anode, a cathode, and a proton exchange membrane sandwiched therebetween. The flow field plate is also known as a flow bed or a separator. The flow field plate is generally made of an electrically conducting material. In each fuel cell, the membrane electrode assembly is sandwiched between the two flow field plates. One or more flow channels are formed on one or two surfaces of the flow field plate for transporting the gases for reaction, as well as for removing the result products, such as water, vapor, or electrons, out of the flow plate. The current collector plate is generally made of an electrically conducting material. In the fuel cell, the flow field plates are generally located between the two current collector plates. Because of the electric conduction of the current collector plate, in some fuel cells the flow field plates also function as current collector plates.

In a typical fuel cell, some flow channels are formed on one surface of the flow field plate. An electro-catalyst layer is formed on the surface having the flow channels of the flow field plate. The fuel cell uses an electro-catalyst to improve the efficiency of fuel. However, the particles of the electro-catalyst layer are very small, generally in the micron or nanometer range, so a portion of the reactive gas cannot fully react and is wasted.

Another problem of the typical fuel cell is that an interface of the membrane electrode assembly and the flow field plate has bad electrical conduction. Thus, the fuel cell cannot export electrons to the load effectively.

What is need, therefore, is a fuel cell that can increase the efficiency of fuel and electric conduction.

### SUMMARY

In a first preferred embodiment, a fuel cell comprises two flow field plates each having an inner surface and a membrane electrode assembly sandwiched therebetween. A plurality of flow channels is formed on the inner surface facing the membrane electrode assembly A carbon material layer is formed on the inner surface in each of the flow channels and a catalyst layer is deposited on the carbon material layer.

In a second preferred embodiment, a fuel cell assembly comprises a plurality of flow field plates and a plurality of membrane electrode assemblies. Each membrane electrode assembly is sandwiched between the adjacent two flow field plates. The flow plates each have at least one surface facing the membrane electrode assembly. A plurality of flow channel is formed on the at least one surface. A carbon material layer is formed on the at least one surface in each of the flow channels and a catalyst layer is formed on the carbon material layer.

In a third preferred embodiment, a method for manufacturing a fuel cell comprises the steps of: providing two flow field plates each having flow channels formed on a surface thereof; forming a carbon material layer on the surface in each of the flow channels; depositing a catalyst layer on the carbon material layer; assembling the flow field plates and a membrane electrode assembly thereby forming the fuel cell.

Other advantages and novel features will become more apparent from the following detailed description of present fuel cell, fuel cell assembly, and method for manufacturing the fuel cell, when taken in conjunction with the accompanying drawings.

### BRIEF DESCRIPTION OF THE DRAWINGS

Many aspects of the fuel cell, fuel cell assembly and method for manufacturing the fuel cell can be better understood with reference to the following drawings. The components in the drawings are not necessarily to scale, the emphasis instead being placed upon clearly illustrating the principles of the present invention Moreover, in the drawings, like reference numerals designate corresponding parts throughout the several views.

FIG. 1 is an exploded, isometric view of a fuel cell, in accordance with a first preferred embodiment.

FIG. 2 is a cross-sectional view of a flow field plate of FIG. 1, taken along the line II-II thereof.

FIG. 3 is an exploded, isometric view of a fuel cell assembly, in accordance with a second preferred embodiment.

FIG. 4 is a flowchart of a method for manufacturing a fuel cell, in accordance with a third preferred embodiment.

FIG. 5 is a schematic, cross-sectional view of one stage in the method of FIG. 4, namely depositing a block layer on one surface of a flow field plate in flow channels.

FIG. 6 is similar to FIG. 5, but showing a first catalyst layer deposited on the block layer of FIG. 5.

FIG. 7 is similar to FIG. 6, but showing carbon nanotubes formed on the first catalyst layer shown in FIG. 6.

FIG. 8 is similar to FIG. 7, but showing a second catalyst layer deposited on the carbon nanotubes shown in FIG. 7.

### DETAILED DESCRIPTION OF THE EMBODIMENTS

Reference will now be made to the drawing figures to describe the preferred embodiment of the present invention in detail.

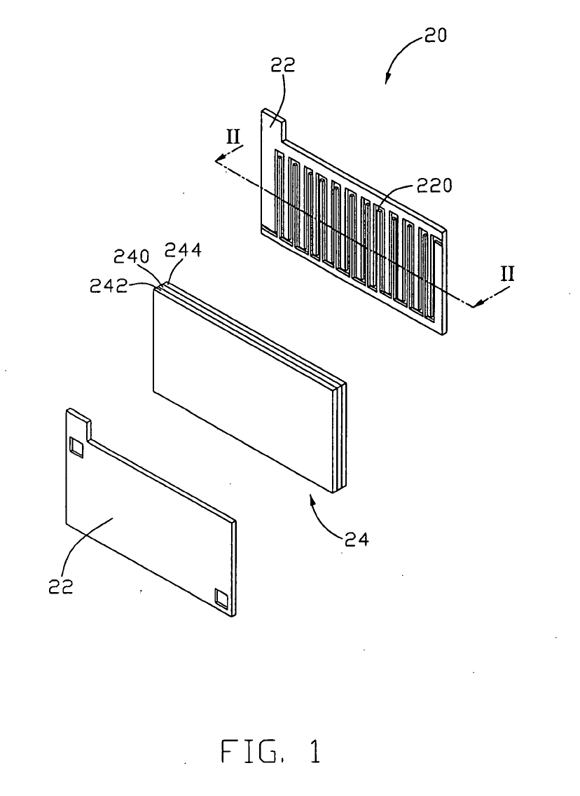

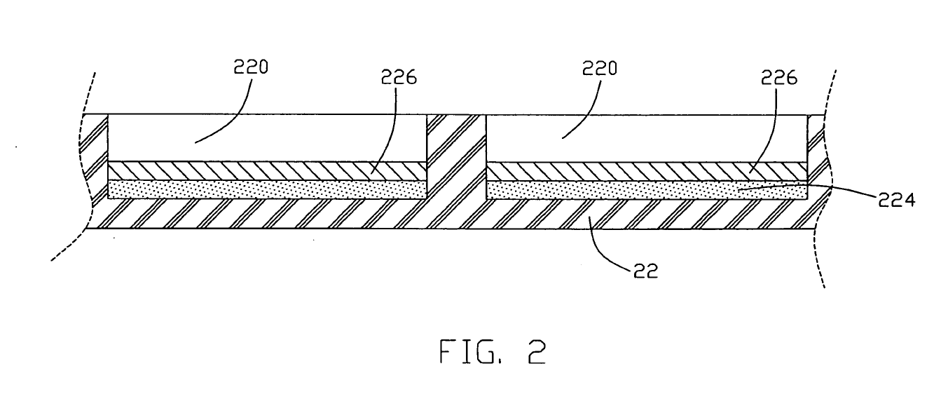

Referring to FIGS. 1 and 2, a fuel cell 20 is shown in accordance with a first embodiment. The fuel cell 20 includes two flow field plates 22 and a membrane electrode assembly 24. The membrane electrode assembly 24 is sandwiched between the two flow field plates 22.

The membrane electrode assembly 24 includes a proton exchange membrane 240, an anode 242, and a cathode 244. The anode 242 is located on one surface of the proton exchange membrane 240 and the cathode 244 is located on the other surface. A catalyst layer is formed on at least one surface of the anode 242. At least one surface of the cathode 244 has a catalyst layer formed thereon.

The flow field plate 22 can be made of metal, such as copper, stainless steel, or electrically conducting composite material. One or more flow channels 220 are formed on an inner surface facing the membrane electrode assembly 24 of the flow field plate 22. The flow channels 220 not only distribute fuel gas or oxidizer uniformly, but also remove result products.

The methods for manufacturing the flow channels 220 can be a die-casting process, a stamping process, a milling process, a chemical etching process, or a photo etching process. Each of the flow channels 220 has a concertinaed configuration. A width of each flow channel 220 is in the range from about 10 microns to about 400 microns. A depth of each flow channel 220 is about in the range from about 20 microns to about 10 millimeters.

A carbon material layer 224 is formed in the flow channels 220 to increase the conductivity of the flow field plate 22. The carbon material layer 224 can be carbon nanotubes, carbon nanorods, carbon nanofibers, carbon powder, or a mixture thereof. A thickness of the carbon material layer 224 is in the range from about 200 nanometers to about 400 nanometers.

A catalyst layer 226 is deposited on the carbon material layer 224. The catalyst layer 226 is used for increasing velocity and efficiency of electrochemical reaction when the fuel cell 20 works. The catalyst layer 226 is made of a noble metal, such as platinum, ruthenium, gold, or any combination alloy thereof. A thickness of the catalyst layer 226 is in the range from about 20 nanometers to about 400 nanometers.

In addition, the carbon material layer 224 and the catalyst layer 226 may be not only formed in the flow channels 220, but also may be formed on the whole surface of the flow field plate 22.

A resistance of the carbon material layer 224 is smaller than that of conventional metals. The carbon material layer 224 can increase the electric conductivity of the flow field plate 22. As a carrier of the catalyst layer 226 the carbon material layer 224 can increase activity of the catalyst layer 226, thereby increasing efficiency

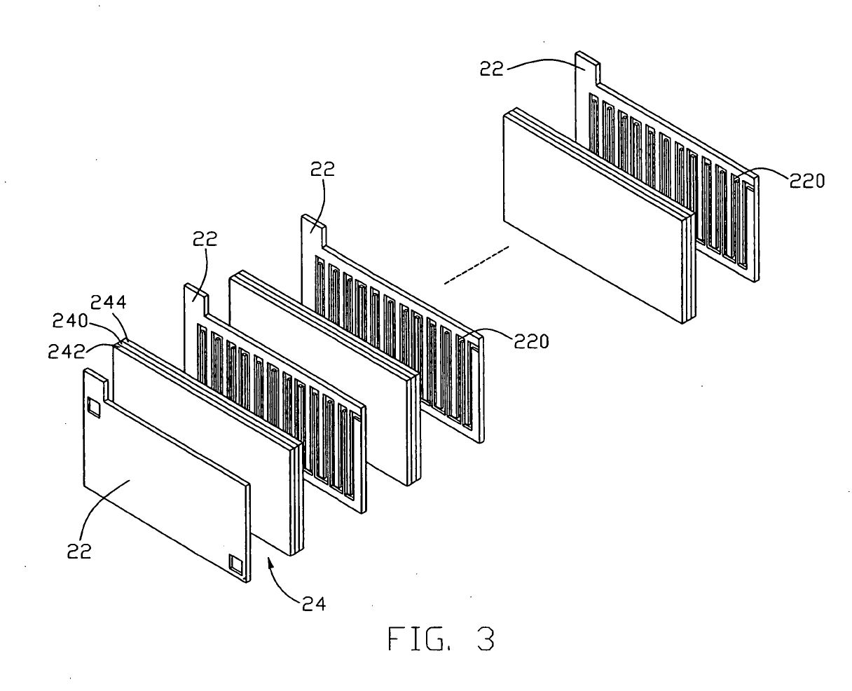

In the practical requirement, many fuel cells 20 are stacked one on another and serially connected to form a fuel cell assembly 30, shown in FIG. 3, that can provide sufficient power. In the fuel cell assembly 30, the flow channels 220 are formed on two opposite surfaces of the flow field plates 22 except two outmost flow field plates 22. One surface of the flow field plate 22 having flow channels 220 acts as an anode surface of a membrane electrode assembly 24 adjacent thereto, and the other surface acts as a cathode surface of another membrane electrode assembly 24 adjacent thereto. A carbon material layer 224 and a catalyst layer 226 are formed on the surfaces having the flow channels 220.

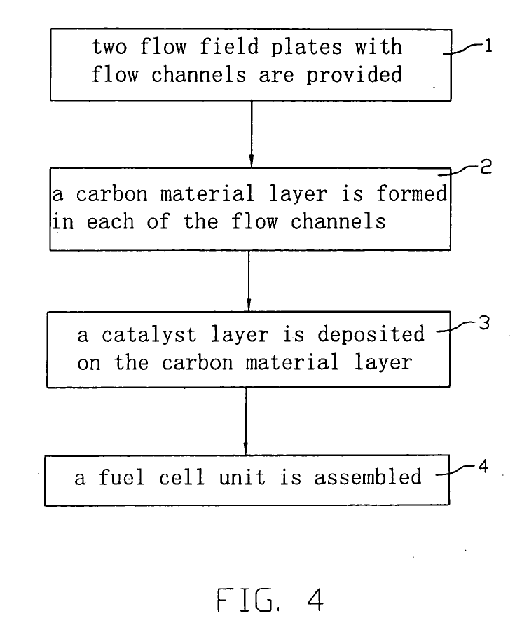

Referring to FIG. 4, a method for manufacturing a fuel cell is shown in accordance with a third preferred embodiment. The method includes the following steps.

In step 1: two flow field plates with flow channels are provided. The flow field plate is made of metal, such as copper, stainless steel, or electrically conducting composite material. A plurality of flow channels is formed on one surface of the flow field plate. A section of each flow channel is V-shaped, U-shaped, arc, rectangle, or other polygon-shaped.

In step 2: a carbon material layer is formed in each of the flow channels.

In step 3: a catalyst layer is deposited on the carbon material layer.

In step 4: a fuel cell is assembled. The flow field plates with the carbon material layer and the catalyst layer are assembled with other portions, such as membrane electrode assembly, to form a fuel cell.

The successive steps of the method according to the third preferred embodiment is described in detail below.

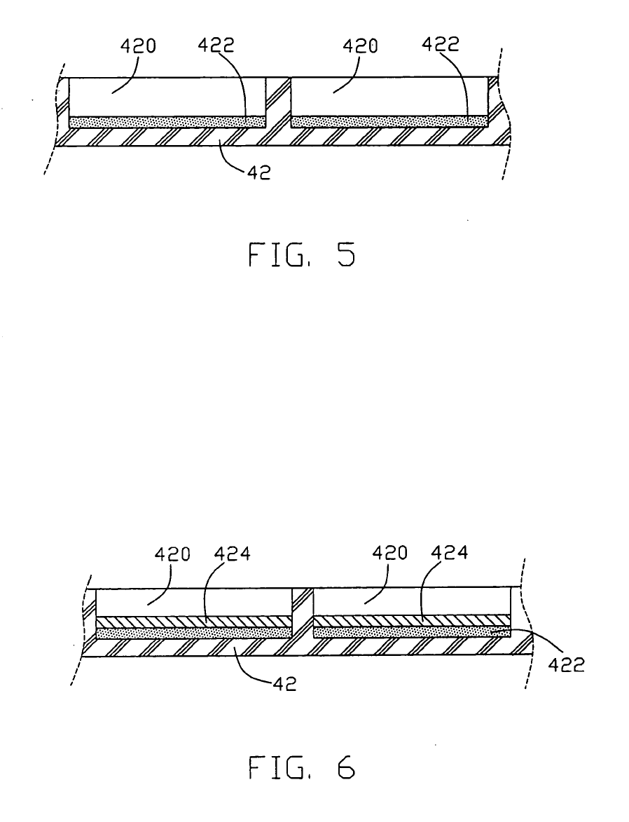

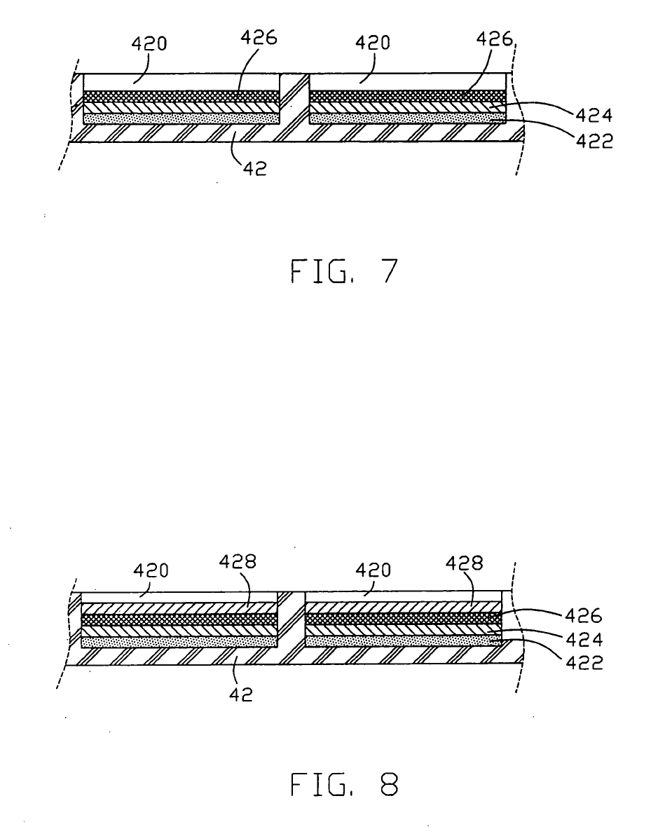

Referring to FIGS. 5 to 8, the flow field plate 42 is made of copper in this embodiment. The die-casting process, stamping process, milling process, chemical etching process, or photo etching process can be utilized to form the flow channels 420. Because the flow field plate 42 is made of metal, it is easy to mass produce by a die-casting process or stamping process.

A block layer 422 is formed on the surface in the flow channels 420 of the flow field plate 42. The block layer 422 can be silicon film layer, nickel film layer, or oxide silicon film layer. A sputtering process, evaporating process, or other appropriate processes can be utilized to form the block layer 422.

A first catalyst layer 424 is formed on the blocking layer 422 for growing carbon nanotubes 426. The carbon nanotubes 426 are known as a carbon material layer. The carbon material layer can be carbon nanorods, carbon nanofibers, carbon powder, or mixture thereof. The first catalyst layer 424 can include iron, cobalt, nickel, or any combination alloy thereof. A sputtering process, evaporating process, or other process can be utilized to form the catalyst layer 424. The block layer 422 is configured for preventing a chemical reaction between the flow field plate 42 made of metal and the first catalyst layer 424. The reaction can adversely affect the activity of the first catalyst layer 424. If the flow field plate 42 is made of non-metal, such as graphite, the block layer 422 is not necessary.

Under a condition of catalyst, the present embodiment uses the chemical vapor depositing method to grow the carbon nanotubes 426 from the first catalyst layer 424. The carbon nanotubes 426 can increase the electric conduction of the flow field plate 42.

A second catalyst layer 428 is formed on the carbon nanotubes 426. The second catalyst layer 428 can increase velocity of reaction and efficiency of the fuel. The second catalyst layer 428 can be made of a noble metal, such as platinum, ruthenium, gold, or any combination alloy thereof. A sputtering process, evaporating process, or other processes can be utilized to form the second catalyst layer 428.

At last, the flow field plate 42 with the block layer 422, carbon nanotubes 426, and the second catalyst layer 428 are jointed with other elements, such as the membrane electrode assembly, to form the fuel cell.

In addition, the block layer 422, carbon nanotubes 426, and the second catalyst layer 428 may be not only formed on the surface in the flow channels 420, but also may be formed on other regions of the surface of the flow field plate 42.

Although the present invention has been described with reference to specific embodiments, it should be noted that the described embodiments are not necessarily exclusive, and that various changes and modifications may be made to the described embodiments without departing from the scope of the invention as defined by the appended claims.

What is claimed is:

1. A fuel cell, comprising:
two flow field plates each having an inner surface, a plurality of flow channels formed on the inner surface, a carbon material layer formed on the inner surface in each of the flow channels, and a catalyst layer deposited on the carbon material layer; and
a membrane electrode assembly sandwiched between the inner surfaces of the flow field plates.

2. The fuel cell as claimed in claim 1, wherein the carbon material layer is comprised of carbon nanotubes, carbon nanorods, carbon nanofibers, carbon powder, or a mixture thereof.

3. The fuel cell as claimed in claim 2, wherein a thickness of the carbon material layer is in the range from 200 nanometers to 400 nanometers.

4. The fuel cell as claimed in claim 1, wherein a width of each of the flow channels is in the range from 10 microns to 400 microns.

5. The fuel cell as claimed in claim 4, wherein a depth of each of the flow channels is in the range from 20 microns to 10 millimeters.

6. The fuel cell as claimed in claim 1, wherein a material of the catalyst layer is selected from the group consisting of platinum, gold, ruthenium, and any combination alloy thereof.

7. The fuel cell as claimed in claim 1, wherein a thickness of the catalyst layer is in the range from 20 nanometers to 400 nanometers.

8. A fuel cell assembly, comprising:
a plurality of flow field plates; and
a plurality of membrane electrode assemblies, each membrane electrode assembly being sandwiched between two adjacent flow field plates; wherein
the flow filed plates each have at least one surface facing the membrane electrode assembly, and a plurality of flow channels formed on the at least one surface, a carbon material layer formed on the at least one surface in each of the flow channels, and a catalyst layer formed on the carbon material layer.

9. A method for manufacturing a fuel cell, comprising the steps of:
providing two flow field plates each having a plurality of flow channels formed on a surface thereof;
forming a carbon material layer on the surface in each of the flow channels;
depositing a catalyst layer on the carbon material layer;
assembling the flow field plates and a membrane electrode assembly thereby forming the fuel cell.

10. The method as claimed in claim 9, further comprising the step of forming a block layer on the surface in each of the flow channels prior to forming the carbon material layer.

11. The method as claimed in claim 10, wherein the block layer is made of a material selected from the group consisting of silicon, nickel, and silicon dioxide.

12. The method as claimed in claim 9, wherein the carbon material layer is comprised of a material selected from the group consisting of carbon nanotubes, carbon nanorods, carbon nanofibers, and carbon powder.

13. The method as claimed in claim 12, further comprising the step of forming carbon nano tubes on the block layer.

14. The method as claimed in claim 9, wherein the catalyst layer is deposited on the carbon material layer by one of a sputtering and an evaporating method.

15. The method as claimed in claim 10, wherein the block layer is deposited by one of a sputtering and an evaporating method.

16. The method as claimed in claim 9, wherein the flow channels are formed by a method selected from the group consisting of die-casting, stamping, milling, chemical etching, and photo etching.

17. The method as claimed in claim 9, wherein the catalyst layer is made of a material selected from the group consisting of platinum, ruthenium, gold, and any combination alloy thereof.
